(19) United States
(12) Patent Application Publication
(10) Pub. No.: US 2007/0002126 A1
(43) Pub. Date: Jan. 4, 2007

(54) Preheating optical disc prior to optically writing to label area of optical disc

(76) Inventors: Greg J. Lipinski, Loveland, CO (US); Kevin L. Colbum, Greeley, CO (US); D. Mitchel Hanks, Ft. Collins, CO (US); Lawrence N. Taugher, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/170,686

(22) Filed: Jun. 29, 2005

(51) Int. Cl. B41J 2/435

(52) U.S. Cl. 347/246

(57) ABSTRACT

An optical disc drive includes an optical mechanism and a preheating mechanism. The optical mechanism optically writes a label to an optically writable label area of an optical disc inserted into the optical disc drive, by heating pixels on the optically writable label area of the optical disc. The preheating mechanism, separate from the optical mechanism, preheats the optical disc prior to the optical mechanism heating the pixels on the optically writable label area of the optical disc.

### BACKGROUND

Many types of optical discs include a data area and a label area. The data area is where the data is written to, whereas the label area allows the user to label the optical disc. A laser or another type of optical beam can be used to read from and/or write to the data area and the label area of an optical disc. For example, in the patent application entitled “Integrated CD/DVD Recording and Label” [attorney docket 10011728-1], filed on Oct. 11, 2001, and assigned Ser. No. 09/976,877, a type of optical disc is disclosed in which a laser or other optical beam can be used to write to the label area of an optical disc.

The laser or other optical beam selectively heats the optically writable label side of such an optical disc in accordance with a desired image. The application of heat to a pixel on the optically writable label side causes the label side to undergo some type of optically visible change at that pixel. The reflectivity of the pixels of the optically writable label side that are heated in this manner is different after heating than other unheated parts of the label area, thus producing the desired image. However, the length of time needed to sufficiently heat the corresponding pixels of the optically writable label side to realize a desired image may require upwards of twenty minutes or more, which can be inconvenient.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated.

FIG. 1 is a diagram of an optical disc drive, according to an embodiment of the invention.

FIG. 2 is a diagram depicting an optical disc drive having a preheating mechanism that is capable of moving radially relative to an optical disc, according to an embodiment of the invention.

FIG. 3 is a diagram depicting how the regions that can be preheated by a preheating mechanism of an optical disc drive can be larger than, but still encompass or include, corresponding pixels that can be heated and thus be optically written to by an optical mechanism of the drive, according to an embodiment of the invention.

FIG. 4 is a diagram depicting an optical disc drive having a preheating mechanism that is stationary and that includes a number of preheating elements, according to an embodiment of the invention.

FIGS. 5A and 5B are diagrams depicting how each preheating element of the preheating mechanism of FIG. 4 can correspond to one, or more than one, radial position of the optical mechanism of the optical disc drive, according to varying embodiments of the invention.

FIG. 6 is a block diagram of an optical disc drive including a preheating mechanism to preheat an optical disc inserted into the optical disc drive as a whole, and a temperature sensor to determine the temperature of the optical disc, according to an embodiment of the invention.

FIG. 7 is a flowchart of a method for optically writing an image to the optically writable label area of an optical disc, where the image is optically written to the label area more quickly as a result of preheating, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Optical Disc Drive with Preheating Mechanism

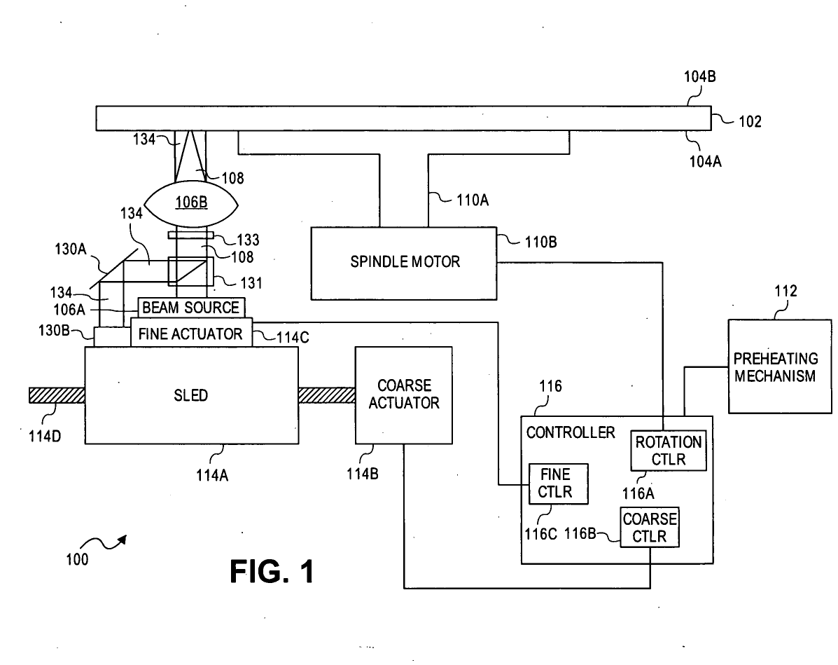

FIG. 1 shows an optical disc drive 100, according to an embodiment of the invention. The optical disc drive 100 is for reading from and/or writing to an optical disc 102 inserted into the optical disc drive 100 and that has a label area and a data area. In one embodiment, the label area of disc 102 is a label side 104A and the data area is a data side 104B opposite the label side 104A. More specifically, the optical disc drive 100 is for reading from and/or writing to an optically writable label side 104A of the optical disc 102, and/or an optically writable data side 104B of the optical disc 102, which are collectively referred to as the sides 104 of the optical disc 102.

The optically writable data side 104B of the optical disc 102 includes a data region on which data may be optically written to and/or optically read by the optical disc drive 100. The data side 104B is thus the side of the optical disc 102 to which binary data readable by the optical disc drive 100 and understandable by a computing device is written, and can be written by the optical disc drive 100 itself. For instance, the data side 104B may be the data side of a compact disc (CD), a CD-readable (CD-R), which can be optically written to once, a CD-readable/writable (CD-RW), which can be optically written to multiple times, and so on. The data side 104B may further be the data side of a digital versatile disc (DVD), a DVD-readable (DVD-R), or a DVD that is readable and writable, such as a DVD-RW, a DVD-RAM, or a DVD+RW. The data side 104B may further be the data side of a high-capacity optical disc, such as a Blu-ray optical disc, and so on. Furthermore, there may be a data region on each side of the optical disc 102, such that the optical disc is double sided, and such that there is a label region on at least one of the sides of the disc.

The label side 104A is the side of the optical disc 102 to which visible markings can be optically written to realize a desired label image. For instance, the label side 104A may be part of an optical disc that is disclosed in the previously filed patent application assigned Ser. No. 09/976,877, which discloses an optically writable label side of an optical disc. It is noted that in other embodiments at least one of the sides 104A and 104B of the optical disc 102 may have both label regions and data regions.

The optical disc drive 100 is depicted in FIG. 1 as including a beam source 106A and an objective lens 106B, which are collectively referred to as the optical mechanism 106. The beam source 106A generates an optical beam 108 that is focused by the objective lens 106B onto the optical disc 102. In some embodiments the optical beam source 106A may be a laser beam source, such that the optical beam 108 is a laser beam. The optical mechanism 106 may include other components, in addition to and/or in lieu of those depicted in FIG. 1. For example, the optical mechanism 106 may include one or more mirrors, as well as a photodetector, so that reflections of the beam 108 off the optical disc 102 can be directed to the photodetector by the mirrors and detected by the photodetector. As another example, the optical mechanism 106 may include polarizing beam splitters, quarter-wave plates, voice coils, and so on.

The optical mechanism 106 is capable of optically writing an image to the optically writable label side 104A of the optical disc 102. The optical mechanism 106 accomplishes such optical image writing by selectively heating pixels on the label side 104A, via the optical beam 108 that the optical mechanism 106 generates, in accordance with an image. When the surface temperature of a pixel on the label side 104A exceeds or is equal to a threshold temperature, due to heating by the optical beam 108 generated by the optical mechanism 106, for a sufficient length of time, it undergoes an optically visible change. This results in the pixel having a different reflectivity as compared to pixels that have not been heated past this threshold temperature. Thus, the optical mechanism 106 heats pixels on the label side 104A to at least the threshold temperature for a sufficiently long period of time to optically write to these pixels.

A pixel is defined herein as a position on the label side 104A of the optical disc 102 at which the optical mechanism 106 can write, or not write, an optically visible mark, depending on the dictates of the desired image to be written to the label side 104A of the optical disc 102. Stated another way, a desired image can be mapped to or over the pixels of the label side 104A of the optical disc 102, such that some pixels have marks optically written thereto, and some pixels do not have marks optically written thereto, so that the end result is the image being optically written to the label side 104A of the optical disc 102. That the optical mechanism 106 selectively writes to the pixels on the label side 104A of the optical disc 102 to form the desired marks means that for any given pixel, it may or may not heat the pixel, such that the desired visible image is ultimately optically written to the label side 104A of the optical disc 102.

The optical disc drive 100 is also depicted in FIG. 1 as including a preheating mechanism 112. The preheating mechanism 112 is depicted in FIG. 1 as a block diagram component that can be controlled by the controller 116. However, specific embodiments of the preheating mechanism 112 are described in subsequent sections of the detailed description. The preheating mechanism 112 is separate from the optical mechanism 106. That is, the optical beam 108 that is generated by the optical mechanism 106 to optically write to the optically writable label side 104A of the optical disc 102 is not the same mechanism that achieves preheating. The optical mechanism 106 is different from the preheating mechanism 112, and the optical beam 108 generated by the optical mechanism 106 is not used for preheating.

The preheating mechanism 112 preheats pixels on the optically writable label side 104A of the optical disc 102, prior to the optical mechanism 106 heating the pixels to optically write to them, so that the optical mechanism 106 does not have to heat the pixels as much in order to write to the pixels. For instance, the label side 104A may be at a given ambient temperature. Without the preheating mechanism 112, the optical mechanism 106 has to heat a pixel on the label side 104A from this ambient temperature to at least the threshold temperature at which the label side 104A undergoes a change in order to write to the pixel.

However, the preheating mechanism 112 may instead preheat the pixel to a preheated temperature that is greater than the ambient temperature, but still less than the threshold temperature at which the label side 104A undergoes a change. The optical mechanism 106 therefore heats the pixel from the preheated temperature (or in some embodiments from slightly less than the preheated temperature, if the pixel has slightly cooled since being preheated) to at least the threshold temperature to optically write to the pixel. The optical mechanism 106, in other words, does not have to heat the pixel as much as it would if the preheating mechanism 112 were not present, since the preheating mechanism 112 preheats the pixel from an ambient temperature to a preheated temperature.

Preheating the pixels on the optically writable label side 104A before they are optically written, to in accordance with a desired image can result in the image being optically written to the label side 104 more quickly than if the pixels were not preheated. This is because the length of time the optical mechanism 106 has to generate the optical beam 108 incident to any given pixel to optically write to the pixel is less when the pixel is preheated. For example, if the optical mechanism 106 has to increase the surface temperature of the label side 104A of the optical disc 102 at a pixel from the ambient temperature to the threshold temperature, the optical beam 108 may have to remain incident to the pixel for X microseconds to achieve this temperature increase. However, if the optical mechanism has to increase the surface temperature of the label side 104A at this pixel from just the preheated temperature to the threshold temperature, the optical beam 108 may only have to remain incident to the pixel for X/2, X/3, or X/4 microseconds. In one embodiment, the value X may be between 50 and 170 microseconds, such as 100 or 169 microseconds.

It is noted that the terminology “heating a pixel” of the optically writable label side 104A of the optical disc 102, or “preheating a pixel” of the label side 104A, is used herein as shorthand to mean heating or preheating the optically writable label side 104A at the location of the pixel. That is, a pixel is a logical position on the label side 104A of the optical disc 102, and as such technically cannot be heated or preheated. Therefore, the terminology heating a pixel or preheating a pixel means that the label side 104A is preheated or heated at this pixel, or position, on the label side 104A.

The optical disc drive 100 is also depicted in FIG. 1 as including a spindle 110A and a spindle motor 110B, which are collectively referred to as the first motor mechanism 110. The spindle motor 110B rotates the spindle 110A, such that the optical disc 102 correspondingly rotates. The first motor mechanism 110 may include other components besides those depicted in FIG. 1. For instance, the first motor mechanism 110 may include a rotary encoder or another type of encoder to provide for control of the spindle motor 110B and the spindle 110A.

The optical disc drive 100 is further depicted in FIG. 1 as including a sled 114A, a coarse actuator 114B, a fine actuator 114C, and a rail 114D, which are collectively referred to as the second motor mechanism 114. The second motor mechanism 114 moves the optical mechanism 106 to radial locations relative to a surface of the optical disc 102. The sled 114A may also be referred to more generally as a support. The coarse actuator 114B is or includes a motor that causes the sled 114A, and hence the fine actuator 114C and the optical mechanism 106 situated on the sled 114A, to move radially relative to the optical disc 102 on the rail 114D. The coarse actuator 114B thus provides for coarse or large radial movements of the fine actuator 114C and the optical mechanism 106.

By comparison, the fine actuator 114C also is or includes a motor, and causes the optical mechanism 106 to move radially relative to the optical disc 102 on the sled 114A. The fine actuator 114C thus provides for fine or small movements of the optical mechanism 106. The second motor mechanism 114 may include other components besides those depicted in FIG. 1. For instance, the second motor mechanism 114 may include a linear encoder or another type of encoder to provide for control of the coarse actuator 114B and the sled 114A. Furthermore, either or both of the motor mechanisms 110 and 114 may be considered as the movement mechanism of the optical disc drive 100.

It is noted that the utilization of a fine actuator 114C and a coarse actuator 114B, as part of the second motor mechanism 114, is representative of one, but not all, embodiments of the invention. That is, to radially move the optical mechanism 106 in relation to the optical disc 102, the embodiment of FIG. 1 uses both a fine actuator 114C and a coarse actuator 114B. However, in other embodiments, other types of a second motor mechanism 114 can be used to radially move the optical mechanism 106 in relation to the optical disc 102, which do not require both a fine actuator 114C and a coarse actuator 114B. For instance, a single actuator or other type of motor may alternatively be used to radially move and position the optical mechanism 106 in relation to the optical disc 102.

The optical disc drive 100 is finally depicted in FIG. 1 as including a controller 116. The controller 116 can in one embodiment include a rotation mechanism 116A, a coarse actuator mechanism 116B, and a fine actuator mechanism 116C. The mechanisms 116 may each be implemented in software, hardware, or a combination of software and hardware. The rotation mechanism 116A controls movement of the spindle motor 110B, and thus controls rotation of the optical disc 102 on the spindle 110A, such as the angular velocity of the rotation of the optical disc 102. The coarse actuator mechanism 116B controls the coarse actuator 114B, and thus movement of the sled 114A on the rail 114D.

The fine actuator mechanism 116C controls the fine actuator 114C, and thus movement of the beam source 106A on the sled 114A. The controller 116 may further include other components besides those depicted in FIG. 1. For instance, the controller 116 can be responsible for turning on and off, and focusing, the optical beam 108, via control of the beam source 106A and the objective lens 106B, and/or for turning on and off the preheating mechanism 112. Furthermore, as can be appreciated by those of ordinary skill within the art, the components depicted in the optical disc drive 100 are representative of one embodiment of the invention, and do not limit all embodiments of the invention.

Radially Movable Preheating Mechanism

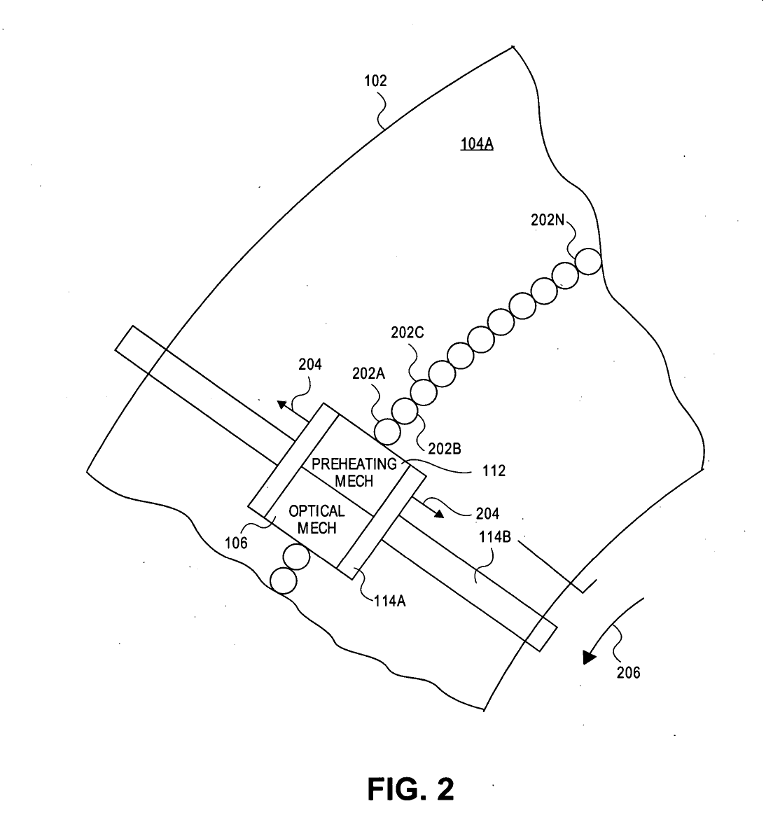

FIG. 2 shows the preheating mechanism 112 in accordance with an embodiment of the invention in which the mechanism 112 is radially movable in relation to the optical disc 102. In particular, the preheating mechanism 112 may be situated on the sled 114A that can be moved radially in relation to the optical disc 102 on the rail 114B, as indicated by the arrows 204. The optical mechanism 106 is also situated on the sled 114A. The preheating mechanism 112 may be situated in front of, or before, the optical mechanism 106 on the sled 114A, with respect to the rotation of the optical disc 102, as indicated by the arrow 206. That is, for a given position or pixel on the optically writable label side 104A of the optical disc 102, the position will pass incident to the preheating mechanism 112 before the position passes incident to the optical mechanism 106.

For example purposes, a number of pixels 202A, 202B, 202C, . . . , 202N, collectively referred to as the pixels 202, are depicted in FIG. 2. As has been described, the pixels 202 are positions on the optically writable label side 104A of the optical disc 102 to which the optical mechanism 106 is capable of optically writing. The pixels 202 do not actually physically exist on the label side 104A, but are depicted in FIG. 2 for illustrative clarity and convenience. As the optical mechanism 106 passes relative to a given pixel, it may or may not optically write to the pixel. Furthermore, the pixels 202 are depicted in FIG. 2 as being part of a concentric track. In such an embodiment, there are thus pixels on each of a number of concentric tracks of the label side 104A of the optical disc 102 so as to allow formation of a two-dimensional image. In another embodiment, the track may be a spiral track extending from the inside edge of the label side 104A to the outside edge of the label side 104A.

The embodiment of FIG. 2 operates generally as follows. The sled 114A is moved on the rail 114B to a desired radial position relative to the optical disc 102, while the optical disc 102 is rotating. Due to rotation of the optical disc 102, as indicated by the arrow 206, the pixel 202A first passes incident to the preheating mechanism 112. The preheating mechanism 112 preheats the pixel 202A from an ambient temperature to a preheated temperature less than the threshold temperature at which the label side 104A undergoes a change at the pixel 202A such that the pixel 202A is written. The preheated temperature may be particularly specified and potentially verified by a sensor or other feedback mechanism, or it may be presumed that heating a given pixel for a certain length of time achieves sufficient preheating, such that the preheated temperature is not particularly specified.

Next, the pixel 202A, due to the rotation of the optical disc 102, as indicated by the arrow 206, passes incident to the optical mechanism 106. If the optical mechanism 106 is to write to the pixel 202A, it heats the pixel 202A from the preheated temperature (or slightly below the preheated temperature, where cooling of the pixel 202A may have occurred) to the threshold temperature at which the label side 104A undergoes a change at the pixel 202A. In this way, the pixel 202A is written.

While the pixel 202A is incident to the optical mechanism 114A, the pixel 202B may be incident to the preheating mechanism 112, such that preheating of the pixel 202B can occur while heating (writing) of the pixel 202A may be occurring. Similarly, while the pixel 202B is incident to the optical mechanism 114A, the pixel 202C is incident to the preheating mechanism 112, so that heating of the pixel 202B and preheating of the pixel 202C can occur at the same time. Employing a preheating mechanism 112 separate from the optical mechanism 106 thus allows for one pixel to be heated while another pixel is being preheated, where a given pixel is first preheated and then heated.

To optically write a desired image to the optically writable label side 104A of the optical disc 102, the optical mechanism 106 selectively writes to, or heats, the pixels on the label side 104A. That is, some pixels are written to, by being heated, and other pixels are not written to, and thus are not heated. In one embodiment, the preheating mechanism 112 is always turned on, and thus always preheats a given pixel, regardless of whether or not the optical mechanism 106 will subsequently heat the pixel to optically write to the pixel. In another embodiment, however, the preheating mechanism 112 is selectively turned on to preheat a given pixel, depending on whether the optical mechanism 106 will subsequently heat the pixel to optically write to the pixel.

The former embodiment has the advantage of being easier to implement. This is because the preheating mechanism 112 is simply turned on for the entire time in which an image is being optically written to the label side 104A. By comparison, the latter embodiment has the advantage of reduced energy consumption. This is because the preheating mechanism 112 is turned on just when it is actually needed, for pixels that will be optically written to by the optical mechanism 106.

The manner by which the preheating mechanism 112 preheats pixels of the optically writable label side 104A of the optical disc 102 is not limited by embodiments of the invention. For instance, the preheating mechanism 112 may be or include an optical device, which has an optical beam source to generate an optical beam like a laser. As additional examples, the preheating mechanism 112 may be or include resistive heating elements, electrical heating elements, as well as other types of heating elements.

It is noted that the preheating of the pixels of the optically writable label side 104A of the optical disc 102 can be performed with less precision in terms of the size of the region preheated than is accomplished during the heating of these pixels to optically write to them, as is now explained in more detail. The optical mechanism 106 heats a given spot on the label side 104A that corresponds in size and position to one of the pixels. Because the heating performed by the optical mechanism 106 actually optically writes to the pixels, if the optical mechanism 106 is imprecise in spot size or position on the label side 104A such that the entire area of a pixel to be written is not adequately preheated, then the resulting optically written image on the label side 104A may suffer in quality.

By comparison, the preheating mechanism 112 may preheat regions of the optically writable label side 104A of the optical disc 102 that are larger than the corresponding pixels on the label side 104A. That is, so long as the region that the preheating mechanism 112 preheats encompasses a given pixel, the region may be larger than the pixel, without degrading image quality of the resulting optically written image on the label side 104A. This is because preheating a pixel does not actually optically write to the pixel, so less precision is needed in terms of the size of the region that is preheated. However, the region that is preheated is desirably at least the same size as, and co-located with, a given pixel—that is, the preheated region encompasses or includes the pixel. In one embodiment, the region is substantially equal in size to a given pixel.

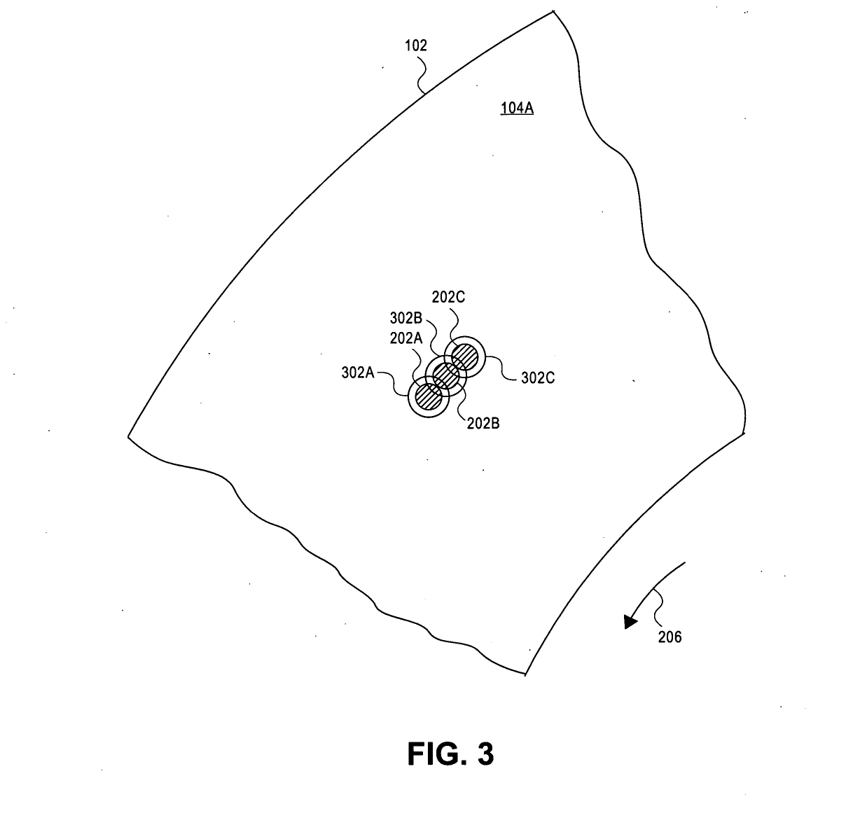

FIG. 3 shows the regions on the optically writable label side 104A of the optical disc 102 that are preheated by the preheating mechanism 112 as being larger than, but encompassing or including, the pixels that can be heated by the optical mechanism 106, according to an embodiment of the invention. The mechanisms 106 and 112 are not depicted in FIG. 3 for illustrative convenience. The pixels 202A, 202B, and 202C are specifically depicted in FIG. 3, and are highlighted for illustrative clarity. The regions 302A, 302B, and 302C correspond to, and encompass or include, the pixels 202A, 202B, and 202C, such that they are larger in size than their corresponding pixels.

As the optical disc 102 rotates, as indicated by the arrow 206, first the preheating mechanism 112 is incident to the region 302A, and can preheat the region 302A and thus the pixel 202A. As the optical disc 102 continues to rotate, the pixel 202A becomes incident to and thus can be heated by the optical mechanism 106 to optically write to the pixel 202A, while at the same time the region 302B that includes the pixel 202B becomes incident to and can be preheated by the preheating mechanism 112. Similarly, as the optical disc 102 continues to rotate, the pixel 202B becomes incident to and can be heated by the optical mechanism 106, while at the same time the region 302C that includes the pixel 202C becomes incident to and can be preheated by the preheating mechanism 112.

Stationary Preheating Mechanism

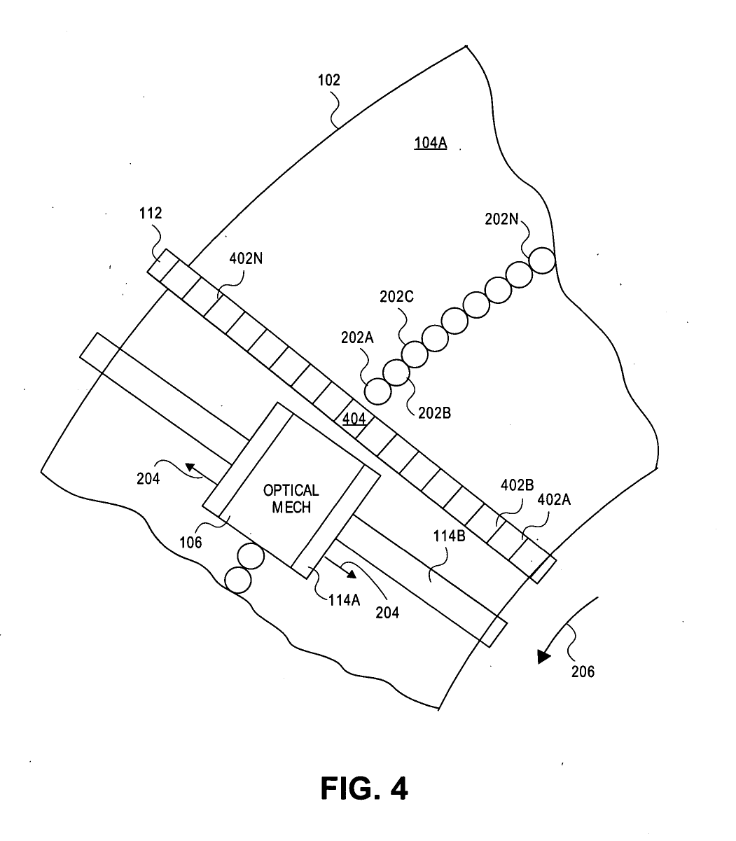

FIG. 4 shows the preheating mechanism 112 in accordance with an embodiment of the invention in which the mechanism 112 is stationary. In particular, the preheating mechanism 112 includes a number of preheating elements 402A, 402B, . . . , 402N, collectively referred to as the preheating elements 402, and which include the preheating element 404 that is particularly discussed as representative of all the preheating elements 402. The preheating elements 402 extend radially from the inside edge of the optical disc 102 to the outside edge of the optical disc 102, and typically do not move. By comparison, the optical mechanism 106 is situated on the sled 114A, which can be moved radially in relation to the optical disc 102 on the rail 114B, as indicated by the arrows 204.

The preheating mechanism 112 is situated in front of, or before, the optical mechanism 106 and the sled 114A with respect to the rotation of the optical disc 102, as indicated by the arrow 206. Thus, as with the embodiment of the invention described in the previous section of the detailed description, for a given position on the optically writable label side 104A of the optical disc 102, the position will pass incident to the preheating mechanism 112 before the position passes incident to the optical mechanism 106. For example purposes the pixels 202A, 202B, 202C, . . . , 202N, collectively referred to as the pixels 202, are also depicted in FIG. 4, and, as in FIG. 2, are positions on the optically writable label side 104A of the optical disc 102 to which the optical mechanism 106 is capable of optical writing.

As has been also described, the pixels 202 are positions on the optically writable label side 104A of the optical disc 102 to which the optical mechanism 106 is capable of optically writing. The pixels 202 do not actually physically exist on the label side 104A, but are depicted in FIG. 4 for illustrative clarity and convenience. As the optical mechanism 106 passes relative to a given pixel, it may or may not optically write to the pixel. Furthermore, the pixels 202 are depicted in FIG. 4 as being part of a concentric track. In such an embodiment, there are thus pixels on each of a number of concentric tracks of the label side 104A of the optical disc 102. In another embodiment, the track may be a spiral track extending from the inside edge of the label side 104A to the outside edge of the label side 104A.

The embodiment of FIG. 4 operates generally as follows. The sled 114A is moved on the rail 114B for the optical mechanism 106 to achieve a desired radial position relative to the optical disc 102, while the optical disc 102 is rotating. One or more of the preheating elements 402 that correspond to this current radial position of the optical mechanism 106 are turned on, while the other of the preheating elements 402 may remain or be turned off. In the particular situation in FIG. 4, the preheating element 404 is particularly turned on as corresponding to the current radial position of the optical beam 108 generated by the optical mechanism 106.

Due to rotation of the optical disc 102, as indicated by the arrow 206, the pixel 202A first passes incident to the preheating element 404 of the preheating mechanism 112. The preheating element 404 preheats the pixel 202A from an ambient temperature to a preheated temperature less than the threshold temperature at which the label side 104A undergoes a change at the pixel 202A such that the pixel 202A is written. As in the embodiment of FIG. 2, the preheated temperature may be particularly specified, or may not be particularly specified.

Next, the pixel 202A, due to the rotation of the optical disc 102, passes incident to the optical mechanism 106. If the optical mechanism 106 is to write to the pixel 202A, it heats the pixel 202A from the preheated temperature (or slightly below the preheated temperature, where cooling of the pixel 202A may have occurred) to the threshold temperature at which the label side 104A undergoes a change to the pixel 202A. In this way, the pixel 202A is written.

While the pixel 202A is incident to the optical mechanism 114A, the pixel 202B, or another of the pixels 202, such as the pixel 202C, may be incident to the preheating element 404, depending on how closely the preheating mechanism 112 is situated relative to the optical mechanism 106. Thus, employing a preheating mechanism 112 separate from the optical mechanism 106 thus allows for one pixel to be heated while another pixel is being preheated, where a given pixel is first preheated and then heated. The process of preheating a pixel, and then potentially heating the pixel to optically write to the pixel, is repeated for all of the pixels 202.

As has been described, to optically write a desired image to the optically writable label side 104A of the optical disc 102, the optical mechanism 106 selectively writes to, or heats, the pixels on the label side 104A. That is, some pixels are written to, by being heated, and other pixels are not written to, and thus are not heated. In one embodiment, the one or more preheating elements of the preheating mechanism 112 that correspond to the current radial position of the optical mechanism 106 are always turned on, and thus always heat a given pixel, regardless of whether or not the optical mechanism 106 will subsequently heat the pixel to optically write to the pixel. In another embodiment, the one or more preheating elements that correspond to the current radial position of the optical mechanism 106 are selectively turned on to preheat a given pixel, depending on whether the optical mechanism 106 will subsequently heat the pixel to optically write to the pixel.

When the optical mechanism 106 is moved to another radial position relative to the optical disc 102, as indicated by the arrows 204′, the preheating element 404 may be turned off, and a different one or more of the preheating elements 402 that correspond to this new radial position of the optical mechanism 106 may be turned on. In one embodiment, each of the preheating elements 402 of the preheating mechanism 112 may correspond to a single radial position of the optical mechanism 106 relative to the optical disc 102. In another embodiment, each of the preheating elements 402 of the preheating mechanism 112 may correspond to one or more radial positions of the optical mechanism 106 relative to the optical disc 102.

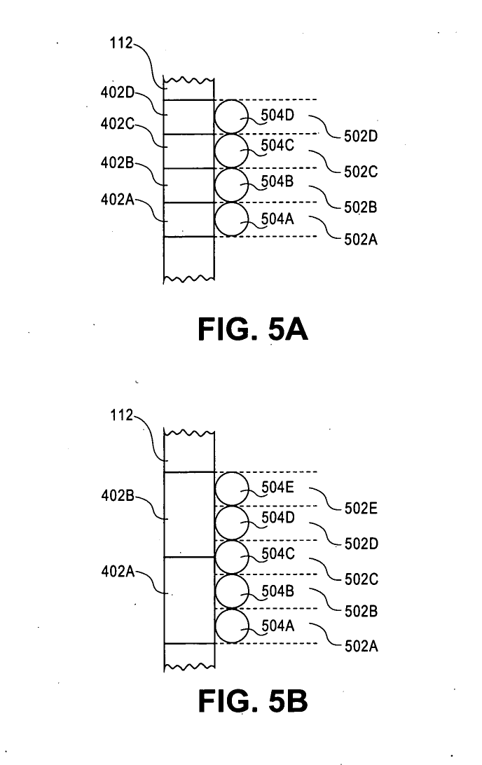

FIG. 5A shows a portion of the preheating mechanism 112 according to this former embodiment, whereas FIG. 5B shows a portion of the preheating mechanism 112 according to this latter embodiment. In FIG. 5A, four different radial positions 502A, 502B, 502C, and 502D, of the optical mechanism 106 in relation to the optical disc 102 (which is not particularly shown in FIG. 5A) are exemplarily depicted. The preheating elements 402A, 402B, 402C, and 402D correspond to these radial positions 502A, 502B, 502C, and 502D, respectively. Thus, when the optical mechanism 106 is moved to the radial position 502A, the preheating element 402A may be turned on, or selectively turned on, so that the preheating element 402A may preheat pixels on the optically writable label side 104A of the optical disc 102 at this radial position 502A, such as the pixel 504A.

Likewise, when the optical mechanism 106 is moved to the radial position 502B, 502C, or 502D, the preheating element 402B, 402C, or 402D, respectively, may be turned on, or selectively turned on, so that the preheating element 402B, 402C, or 402D may preheat pixels at that radial position, such as the pixel 504B, 504C, or 504D. Therefore, in the embodiment of FIG. 5A, just one of the preheating elements 402 needs to be turned on to heat the pixels at a given radial position of the optical mechanism 106 in relation to the optical disc 102. Furthermore, in the embodiment of FIG. 5A, for each radial position of the optical mechanism 106 in relation to the optical disc 102, a different one of the preheating elements 402 is turned on.

In FIG. 5B, five different radial positions 502A, 502B, 502C, 502D, and 502E of the optical mechanism in relation to the optical disc 102 (which is also not particularly shown in FIG. 5B) are exemplarily depicted. Two preheating elements 402A and 402B of the preheating mechanism 112 are shown in FIG. 5B. The preheating element 402A corresponds to the radial positions 502A, 502B, and 502C, whereas the preheating element 402B corresponds to the radial positions 502C, 502D, and 502E. Thus, when the optical mechanism 106 is moved to the radial position 502A or 502B, just the preheating element 402A may be turned on, or selectively turned on, so that the preheating element 402A may preheat pixels on the optically writable label side 104A of the optical disc 102 at that radial position, such as the pixel 504A or 504B.

Furthermore, when the optical mechanism 106 is moved from the radial position 502A to the radial position 502B, the same preheating element 402A corresponds to both these radial positions, so that no other preheating elements need to be turned on or selectively turned on. However, when the optical mechanism 106 is moved to the radial position 502C, both the preheating elements 402A and 402B may be turned on, or selectively turned on, to completely preheat pixels on the optically writable label side 104A of the optical disc 102 at the radial position 502C, such as the pixel 504C. This is because the bottom portions of the pixels at the radial position 502C can be preheated by the preheating element 402A, whereas the top portions of these pixels can be preheated by the preheating element 402B.

When the optical mechanism 106 is moved to the radial position 502D or 502E, just the preheating element 402B may be turned on, or selectively turned on, so that the preheating element 402B may preheat pixels on the optically writable label side 104A of the optical disc 102 at that radial position, such as the pixel 504D or 504E. Thus, when the optical mechanism 106 is moved from the radial position 502C to the radial position 502D, the preheating element 402A may be turned off, since the preheating element 402A corresponds to the radial position 502C but does not correspond to the radial position 502D. By comparison, the preheating element 402B remains on, or is still selectively turned on, since the preheating element 402B corresponds to both the radial positions 502C and 502D.

It is noted that the manner by which the preheating elements 402 of the preheating mechanism 112 preheats pixels of the optically writable label side 104A of the optical disc 102 is also not limited by the embodiments of the invention of FIGS. 4, 5A, and 5B. The preheating elements 402 may each be or include an optical device having an optical beam source to generate an optical beam like a laser. As additional examples, the preheating elements 402 may each be or include one or more resistive heating elements, electrical heating elements, as well as other types of heating elements.

It is further noted that the preheating of the pixels of the optically writable label side 104A of the optical disc 102 can be performed with less precision in terms of the size of the region preheated than is accomplished during the heating of these pixels to optically write to them, as has been described in detail in relation to FIG. 3 in the previous section of the detailed description. Thus, each of the preheating elements 402 of the preheating mechanism 112 may preheat regions of the optically writable label side 104A of the optical disc 102 that are larger than the corresponding pixels on the label side 104A. Therefore, so long as the region that each preheating element 112 of the preheating mechanism 112 preheats encompasses a given pixel, the region may be larger than the pixel, without degrading image quality of the resulting optically written image on the label side 104A.

This is because, as has been described in relation to FIG. 3 in the previous section of the detailed description, preheating a pixel does not actually optically write to the pixel, so less precision is needed in terms of the size of the region that is preheated. However, the region that is preheated by a given preheating element of the preheating mechanism 112 desirably is at least the same size as a given pixel—that is, the preheated region encompasses or includes the pixel. In one embodiment, the region is substantially equal in size to a given pixel.

Whole Heating of Optical Disc by Preheating Mechanism

Embodiments of the invention that have been thus far described in relation to FIGS. 2 and 4 achieve preheating of the optically writable label side 104A of the optical disc 102, by the preheating mechanism 112 on a region-by-region, such as a pixel-by-pixel, basis. That is, regardless of whether the preheating mechanism 112 is movable, as in the embodiment of FIG. 2, or is stationary, as in the embodiment of FIG. 4, the preheating mechanism 112 preheats a single region of the label side 104A, including a desired pixel, at any given time. Thus, a given region including one pixel may be preheated, then the next region including a different pixel may be preheated, and so on.

However, in another embodiment of the invention, the preheating mechanism 112 of FIG. 1 preheats the entire optical disc 102 as a whole, to achieve preheating of the pixels on the optically writable label side 104A of the optical disc 102. For instance, when an image is to be optically written to the label side 104A of the optical disc 102, the preheating mechanism 112 may be turned on to heat the inside of the optical disc drive 100 of FIG. 1, including the optical disc 102, and thus all the pixels on the label side 104A of the optical disc 102. Once the temperature has been increased from the ambient temperature to the preheated temperature, optical writing of the image to the label side 104A of the optical disc 102 by the optical mechanism 106 begins, and the preheating mechanism 112 maintains this preheated temperature.

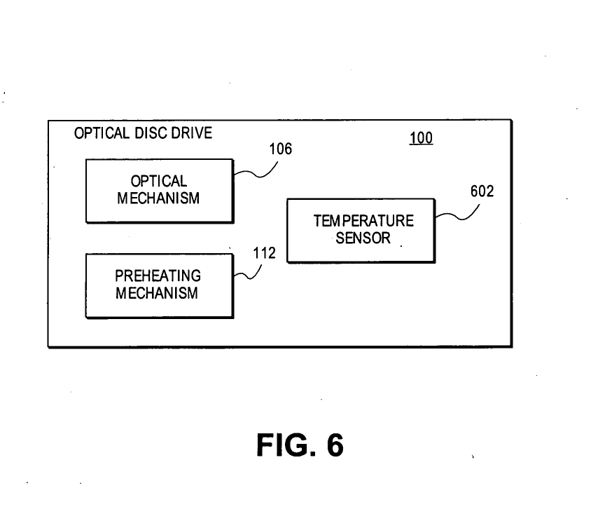

FIG. 6 shows a block diagram of the optical disc drive 100 in accordance with such an embodiment of the invention in which the entire optical disc 102 is preheated as a whole by the preheating mechanism 112. The optical disc drive 100 is specifically depicted in FIG. 6 as including the optical mechanism 106, the preheating mechanism 112, and a temperature sensor 602. The other components of the optical disc drive 100 that have been described in relation to and depicted in FIG. 1 are not shown in FIG. 6 for illustrative convenience. The preheating mechanism 112 in this embodiment of the invention may be a resistive heating element, an electrical heating element, and/or a different type of heating element.

In one embodiment, the temperature sensor 602 may determine whether the temperature inside the drive 100 has reached the desired preheated temperature. It may be presumed that the optically writable label side 104A of the optical disc 102 inserted into the optical disc drive 100 is at this preheated temperature when the temperature inside the drive 100 is at the preheated temperature. Alternatively, a length of time may be waited after the temperature inside the optical drive 100 has reached the preheated temperature to allow the optical disc 102 inserted into the drive 100 to also reach this temperature, where this length of time may be related to the thermal mass, the thermal conductivity, and so on, of the disc 102. In this embodiment, then, the temperature sensor 602 indirectly determines the temperature of the label side 104A. In another embodiment, however, the temperature sensor 602 specifically determines the temperature of the optically writable label side 104A of the optical disc 102 inserted into the optical disc drive 100. In this embodiment, then, the temperature sensor 602 directly determines the temperature of the label side 104A.

Furthermore, in a different embodiment of the invention, the temperature sensor 602 may be absent. In such an embodiment, it may be known that turning on the preheating mechanism 112 for a given period of time achieves a sufficient preheated temperature. Furthermore, it may be known that subsequently turning on the preheating mechanism 112 for a given length of time after having turned off the preheating mechanism 112 for another length of time sufficiently maintains this preheated temperature.

### METHOD AND CONCLUSION

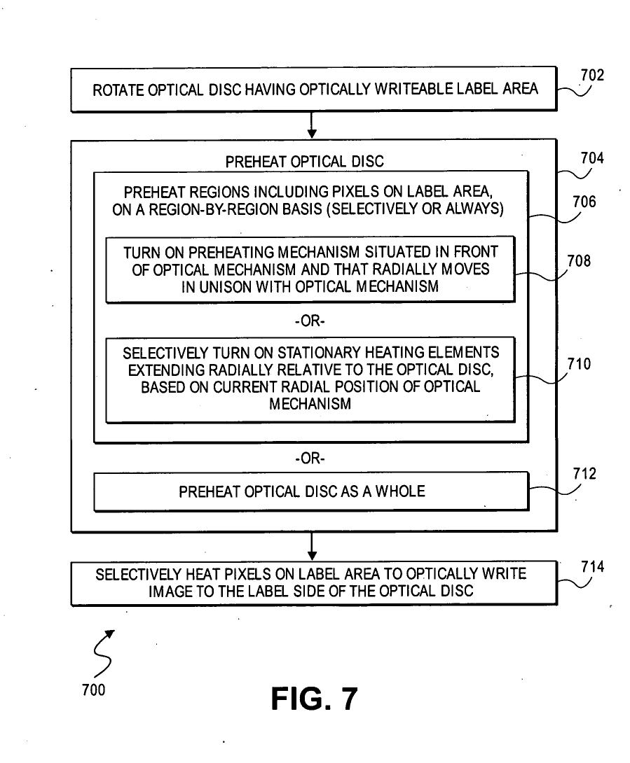

FIG. 7 shows a method 700 for optically writing an image to the optically writable label area of the optical disc 102 by the optical mechanism 106, including preheating the optical disc 102 using the preheating mechanism 112 as has been described, according to an embodiment of the invention. The method 700 may be performed by the components of the optical disc drive 100 that have been described. At least some components of the method 700 may be implemented as computer program parts of a computer program stored on a computer-readable medium. The medium may be a magnetic storage medium, such as a hard disk drive, an optical storage medium, such as an optical disc, and/or a semiconductor storage medium, such as a memory, among other types of computer-readable media. Furthermore, parts of the method 700 may be performed in a different order than is depicted in FIG. 7.

The optical disc 102, having an optically writable label area, is rotated within the optical disc drive 100 (702). As the optical disc 102 is rotated, the optical disc 102 is preheated (704), and pixels on the label area of the optical disc 102 are selectively heated to optically write a desired image to the label area (714). Preheating of the optical disc 102 may be accomplished by preheating regions on the label area that include pixels on a region-by-region basis (706), as has been described in relation to FIGS. 2 and 4, or by preheating the entire optical disc 102 as a whole (712), as has been described in relation to FIG. 6. In one embodiment, the optical disc 102 may be preheated in 704 prior to the optical disc 102 being rotated in 702, such that the preheating of 704 is accomplished prior to the rotation of 702.

Where preheating is accomplished on a region-by-region basis in 706, such preheating may be accomplished for a given region selectively or always. That is, as has been described, a given region may always be preheated, regardless of whether the region encompasses or includes a pixel that will subsequently be heated by the optical mechanism 106 to optically write to the pixel. Alternatively, a given region may selectively be preheated, based on whether the region encompasses or includes a pixel that will subsequently be heated to optically write to the pixel. In this latter situation, a region is not preheated if the pixel that it encompasses will not be subsequently heated, and a region is preheated if the pixel that it encompasses will be subsequently heated.

Furthermore, where preheating is accomplished on region-by-region basis in 706, such preheating may be accomplished by turning on a preheating mechanism 112 that is situated in front of the optical mechanism 106 and that radially moves in unison with the optical mechanism 106 (708), as has been shown in and described in relation to FIG. 2. Alternatively, such preheating may be accomplished by selectively turning on stationary heating elements 402 that extend radially relative to the optical disc 102, based on the current radial position of the optical mechanism 106 (710), as has been shown in and described in relation to FIG. 4. Regardless of how preheating is accomplished, optically writing the image to the label area is accomplished more quickly when the optical disc 102 is preheated than if the optical disc 1.02 were not preheated.

It is noted that, although specific embodiments have been illustrated and described herein, it will be appreciated by those of ordinary skill in the art that any arrangement calculated to achieve the same purpose may be substituted for the specific embodiments shown. For instance, embodiments of the invention have been substantially described in relation to an optical disc drive in which a label is written to an optically writable label side of an optical disc by heating pixels on the label side in accordance with the label. However, other embodiments of the invention are more generally applicable to any type of optical apparatus in which an optically writable surface is written to by heating pixels on the optically writable surface.

In such embodiments, the preheating that has been described can be accomplished by scanning the preheating mechanism over a desired pixel to be written to, to preheat a region including the pixel before the optical mechanism scans over the desired pixel to write to the pixel. Alternatively, a large portion of the optically writable label surface may first be preheated by the preheating mechanism, and then the scanning mechanism employed to optically write to pixels encompassed by this portion of the surface by heating the pixels as desired. This application is intended to cover any adaptations or variations of the disclosed embodiments of the present invention. Therefore, it is manifestly intended that this invention be limited only by the claims and equivalents thereof.

We claim:

1. An optical disc drive comprising:
an optical mechanism to optically write a label to an optically writable label area of an optical disc inserted into the optical disc drive, by heating pixels on the optically writable label area of the optical disc; and,
a preheating mechanism separate from the optical mechanism to preheat the optical disc prior to the optical mechanism heating the pixels on the optically writable label area of the optical disc.

2. The optical disc drive of claim 1, wherein the preheating mechanism is selectively turned on based on whether a pixel on the optically writable label area of the optical disc is to be written to by the optical mechanism, such that the preheating mechanism preheats the pixel before the optical mechanism heats the pixel to optically write to the pixel.

3. The optical disc drive of claim 1, wherein the preheating mechanism is turned on while the optical mechanism is optically writing the label to the optically writable label area of the optical disc, regardless of whether a pixel on the optically writable label area is to be written to by the optical mechanism, such that the preheating mechanism preheats the pixel regardless of whether the optical mechanism is to subsequently heat the pixel to optically write to the pixel.

4. The optical disc drive of claim 1, wherein the preheating mechanism is to preheat a region including a pixel on the optically writable label area of the optical disc prior to the optical mechanism heating the pixel to optically write to the pixel, such that the preheating mechanism preheats the region including the pixel before the optical mechanism heats the pixel to optically write to the pixel.

5. The optical disc drive of claim 4, wherein the optically writable label area of the optical disc has a threshold temperature at which the pixel is optically written thereto by the optical mechanism, such that the preheating mechanism is to preheat the region to a preheated temperature greater than an ambient temperature and less than the threshold temperature, and the optical mechanism is to heat the pixel from the preheated temperature to at least the threshold temperature to optically write to the pixel.

6. The optical disc drive of claim 4, wherein the region including the pixel is substantially equal in size to the pixel.

7. The optical disc drive of claim 4, wherein the region including the pixel is larger in size than the pixel.

8. The optical disc drive of claim 1, wherein the optical mechanism and the preheating mechanism are capable of moving radially relative to the optical disc, the preheating mechanism positioned in front of the optical mechanism with respect to rotation of the optical disc.

9. The optical disc drive of claim 8, further comprising a support on which the optical mechanism and the preheating mechanism are situated, the preheating mechanism situated on the support in front of the optical mechanism with respect to rotation of the optical disc.

10. The optical disc drive of claim 1, wherein the optical mechanism is capable of moving radially relative to the optical disc and the preheating mechanism is stationary.

11. The optical disc drive of claim 10, wherein the preheating mechanism comprises a plurality of preheating elements extending radially relative to the optical disc, the preheating elements selectively turned on in accordance with a current radial position of the optical mechanism relative to the optical disc.

12. The optical disc drive of claim 11, further comprising a support on which the optical mechanism is situated, the preheating elements of the preheating mechanism situated in front of the support with respect to rotation of the optical disc.

13. The optical disc drive of claim 1, wherein the preheating mechanism is to preheat the label area as a whole, rather than preheating the label area on a region-by-region basis.

14. The optical disc drive of claim 13, further comprising a temperature sensor to determine a temperature of the optically writable label area of the optical disc.

15. The optical disc drive of claim 1, wherein the optical mechanism is capable of optically writing the label to the optically writable label area of the optical disc more quickly because the preheating mechanism preheats the optical disc.

16. The optical disc drive of claim 1, wherein the preheating mechanism comprises at least one of: an optical device, an electrical heating element, or a resistive heating element.

17. The optical disc drive of claim 1, wherein the optically writable label area of the optical disc comprises a side of the optical disc.

18. An optical disc drive comprising:
means for optically writing a label to an optically writable label area of an optical disc inserted into the optical disc drive, by heating pixels on the optically writable label area of the optical disc; and,
means for preheating the optical disc prior to the pixels being heated to optically write the label to the optically writable label area of the optical disc.

19. The optical disc drive of claim 18, wherein the means for preheating the optical disc preheats a region including a pixel on the optically writable label area of the optical disc prior to the optical mechanism heating the pixel to optically write to the pixel.

20. The optical disc drive of claim 19, wherein the means for preheating the optical disc selectively preheats the region based on whether the optical mechanism is to heat the pixel to optically write to the pixel.

21. A method comprising:
rotating an optical disc having a label area optically writable by heating the label area;
as the optical disc is being rotated,
preheating the optical disc; and,
selectively heating pixels on the label area to optically write an image to the label area of the optical disc.

22. The method of claim 21, wherein preheating the optical disc comprises preheating the optical disc as a whole.

23. The method of claim 21, wherein preheating the optical disc comprises preheating a region including a pixel, regardless of whether the pixel is to be optically written to.

24. The method of claim 21, wherein preheating the optical disc comprises preheating a region including a pixel, based on whether the pixel is to be optically written to, prior to the pixel being optically written to via heating.

25. The method of claim 21, wherein preheating the optical disc comprises preheating the optical disc to a preheated temperature greater than an ambient temperature and less than a threshold temperature at which a pixel is optically written, and selectively heating the pixels on the label area comprises heating the pixel from the preheated temperature to at least the threshold temperature to optically write to the pixel.

26. The method of claim 21, wherein preheating the optical disc comprises turning on a preheating mechanism situated in front of an optical mechanism separate from the preheating mechanism, the preheating mechanism and the optical mechanism radially movable in unison relative to the optical disc, the optical mechanism selectively heating the pixels on the label area to optically write the image to the label area of the optical disc.

27. The method of claim 21, wherein preheating the optical disc comprises selectively turning on a plurality of heating elements stationarily extending radially relative to the optical disc, in accordance with a current radial position of an optical mechanism relative to the optical disc, the optical mechanism radially movable relative to the optical disc and selectively heating the pixels on the label area to optically write the image to the label area of the optical disc.

28. The method of claim 21, wherein optically writing the image to the label area of the optical disc is accomplished more quickly because the optical disc is being preheated.

29. A computer-readable medium having a computer program stored thereon comprising:
a first computer program part to cause an optical disc to be preheated; and,
a second computer program part to cause a label to be optically written to an optically writable label area of an optical disc by heating pixels on the optically writable label area of the optical disc after the pixels having been preheated.

30. The computer-readable medium of claim 29, wherein the first computer program part is to selectively turn on a preheating element based on at least one of:
a current radial position of an optical mechanism responsible for optically writing the image to the optically writable label area of the optical disc; and,
whether a given pixel on the optically writable label area of the optical disc is to be written to by the optical mechanism.

31. An optical apparatus comprising:
an optical mechanism to optically write to an optically writable surface by heating pixels on the optically writable surface; and,
a preheating mechanism separate from the optical mechanism to preheat the optically writable surface prior to the optical mechanism heating the pixels on the optically writable surface.
